(19) United States
(12) Patent Application Publication
(10) Pub. No.: US 2007/0083644 A1
(43) Pub. Date: Apr. 12, 2007

(54) Capturing, displaying, and re-creating network conversations and state information

(75) Inventors: Olaf A. Miller, Bellevue, WA (US); David N. MacDonald, Mercer Island, WA (US); James J. McNelis, Carnation, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation

(21) Appl. No.: 11/248,396

(22) Filed: Oct. 12, 2005

(51) Int. Cl. G06F 15/173

(52) U.S. Cl. 709/224

(57) ABSTRACT

Graphically representing network frame capture sessions, network frame data, network conversations and network state data using network protocol parsers formed from a network protocol script and enabling interaction with the network frames, conversations, scripts, and parsers is disclosed. Capture session frame data and capture session context data are stored in a file that can be used to reconstruct the capture session on computing devices other than the computing device involved in the network frame capture and not connected to the network involved in the network frame capture. Dynamically representing the execution of network protocol scripts; enabling the setting of breakpoints in, and single stepping through, network protocol scripts; and modifying protocol scripts and applying the modifications while the protocol scripts are being used are supported.

### BACKGROUND

A network data stream is composed of a plurality of frames. A frame is a logical unit of data organized specifically for transmission. A frame may also be referred to as a packet, block, or cell. The assembly, transmission, and extraction of frames and extraction of payloads from frames are governed by standard sets of rules called protocols. A network protocol, i.e., a protocol, is a set of rules used by computers to communicate via a network. Protocols are organized into stacks of layers called protocol stacks, i.e., stacks. The layers in a stack encapsulate and organize functions required to assemble, i.e., add specific data to, and disassemble, i.e., extract specific data from, frames.

Each layer in a stack provides a well defined set of functions and services. The functions and services are applied to frames to assemble frames and pass the frames down a stack or disassemble frames and pass frames up a stack. Except for the lowest layer, i.e., the physical network layer, each layer uses the services of the layer below. Assembled frames are passed from one computer to another computer using the physical network layer. Each layer communicates with the layer's peer layer in another computer. Although the logical communication is between peer layers on different computers, the actual flow of data is down the protocol stack on the sending computer and up the protocol stack on the receiving computer. When a frame is sent from a layer on a computer to the layer's peer layer on another computer, the layer calls a function in the layer below it to send the data. Only the lowest layer actually sends the data to another computer.

The process of interpreting frames extracted from a network data stream, i.e., a stream, according to the rules of a protocol, is called “parsing.” A computer software program or program component that performs parsing functions is called a “parser.” A computer program that uses one or more parsers to analyze a stream is called a network monitor, i.e., a monitor, or a protocol analyzer. Monitors capture, i.e., identify and extract, frames from a stream on a network and output the frames in a human-readable format. A “capture session” is a span of time in which a monitor operates to capture frames. Often a monitor is coupled to a user interface so that human operators can easily interact with the monitor. To further assist human operators, monitors narrow down a plurality of captured frames to only the frames involved in a specific data exchange. A set of frames that comprise specific data exchange is called a “conversation.”

Functionally, a conversation is a set of frames that are related because each of the frames in the set of frames contains identifiers that are unique to the conversation. A conversation takes place in one protocol layer of the protocol stacks of the communicating computers. It is possible to assemble more than one conversation from the same set of frames because conversations may be assembled for each layer in a protocol stack. If the data that uniquely identifies the frames in a conversation can be identified, a filter can be constructed to capture or view only the frames in the conversation.

Monitor operators must often find and select the information that uniquely identifies the frames in a conversation. This is usually done by capturing a small set of frames on a restricted network during a known information exchange and searching for common values in the frames. This approach is time consuming and, thus, inherently expensive. Even with these restrictions, a monitor operator can be overwhelmed by the amount of data displayed in the user interface of a monitor. Any assistance a monitor and the monitor's user interface can provide to help identify conversations and simplify views of conversations and framed data, makes the monitor more useful.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

A method and apparatus, i.e., a network monitor user interface, including computer-readable medium, for graphically representing network frame capture sessions, network frame data, network conversations, and network state data using one or more network protocol scripts and enabling interaction with the frames, conversations, and scripts is provided.

Capture session frame data and capture session context data can be displayed “live” and/or stored in a file and reconstructed at a later time. Those skilled in the art will appreciate that storing capture session frame data and capture session context data in a file and reconstructing a capture session from the stored frame data and context data may be referred to as “virtualizing” a capture session. Virtualized capture session files may be opened on computing devices other than the computing device involved in the capture session and not connected to the network involved in the capture session.

Dynamically representing the execution of network protocol scripts; enabling the setting of breakpoints in, and single stepping through, network protocol scripts; and modifying protocol scripts and applying the modifications while the protocol scripts are being used are also provided.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a pictorial illustration of an exemplary network monitor user interface;

FIG. 2 is a pictorial illustration of a pane in an exemplary network monitor user interface showing an exemplary tree view of network conversations;

FIG. 3 is a pictorial illustration of a pane of an exemplary network monitor user interface showing detailed information about selected network conversations;

FIG. 4 is a pictorial illustration of a pane of an exemplary network monitor user interface showing detailed information about selected protocols in a frame;

FIG. 5 is a pictorial illustration of a pane of an exemplary network monitor user interface representing information about a frame as low level, i.e., hexadecimal, values;

FIG. 6 is a pictorial illustration of an exemplary network monitor user interface displaying exemplary panes used in a parser debugging mode;

FIG. 7 is a pictorial illustration of a pane of an exemplary network monitor user interface in a parser debugging mode showing a tree view of available protocol parsers;

FIG. 8 is a pictorial illustration of a pane of an exemplary network monitor user interface in a parser debugging mode showing exemplary script for an exemplary protocol parser;

FIG. 9 is a pictorial illustration of a pane of an exemplary network monitor user interface in a parser debugging mode showing an exemplary tree view of an exemplary protocol tree;

FIG. 10 is a pictorial illustration of a pane of an exemplary network monitor user interface in a parser debugging mode representing information about conversations as low level, i.e., hexadecimal values;

FIG. 11 is an exemplary functional flow diagram showing an exemplary network capture virtualization process used to form a project file;

FIG. 12 is an exemplary functional flow diagram showing an exemplary network capture reconstruction process using a project file; and

FIG. 13 is an exemplary functional flow diagram illustrating an exemplary protocol script debugging session.

### DETAILED DESCRIPTION

Embodiments of the invention provide graphical representations of, and interaction with, network frame capture sessions, network frame data, network conversations, and network state data using one or more network protocol scripts. Preferably, the aforementioned capabilities are provided as features of computer software programs referred to by those skilled in the art as “network monitors” but may be provided in other software programs. Preferably, a network monitor operates on a computing device containing a display and processing resources. Processing resources include, but are not limited to, one or more single core microprocessors, one or more multiple core microprocessors, combinations of microprocessors, or electronic or optical circuits able to provide processing functions. A network monitor is used to capture, i.e., identify and extract, frames on a network and to examine the captured frames. A network monitor assembles frames extracted from a network data stream, i.e., a stream, according to protocol rules using one or more “protocol parsers.” Embodiments of the invention also enable network monitors to “virtualize” capture sessions. A capture session is virtualized when the frame data and context data of the capture session are saved together in a file, i.e., a project file. Capture session context data is data describing the state of the network and computing device used in the session such as, but not limited to, process IDs, application icons, network addresses, routes, routers, name servers, and name caches. A virtualized capture session can be reconstructed on computing devices later on the same device, or on devices other than the computing device involved in the network frame capture and not connected to the network involved in the network frame capture. A virtualized capture session is reconstructed by opening the project file in a virtualizing network monitor. In this environment, the user has access to the state that was saved. For instance, “localnetworkaddress” would refer to the local network address when/where the data was captured, rather than the local network address of the viewing machine. State such as network names or aliases can be used in filters, etc. Embodiments of the invention also enable network monitors to dynamically represent the execution of network protocol scripts and to enable the dynamic modification of network protocol scripts.

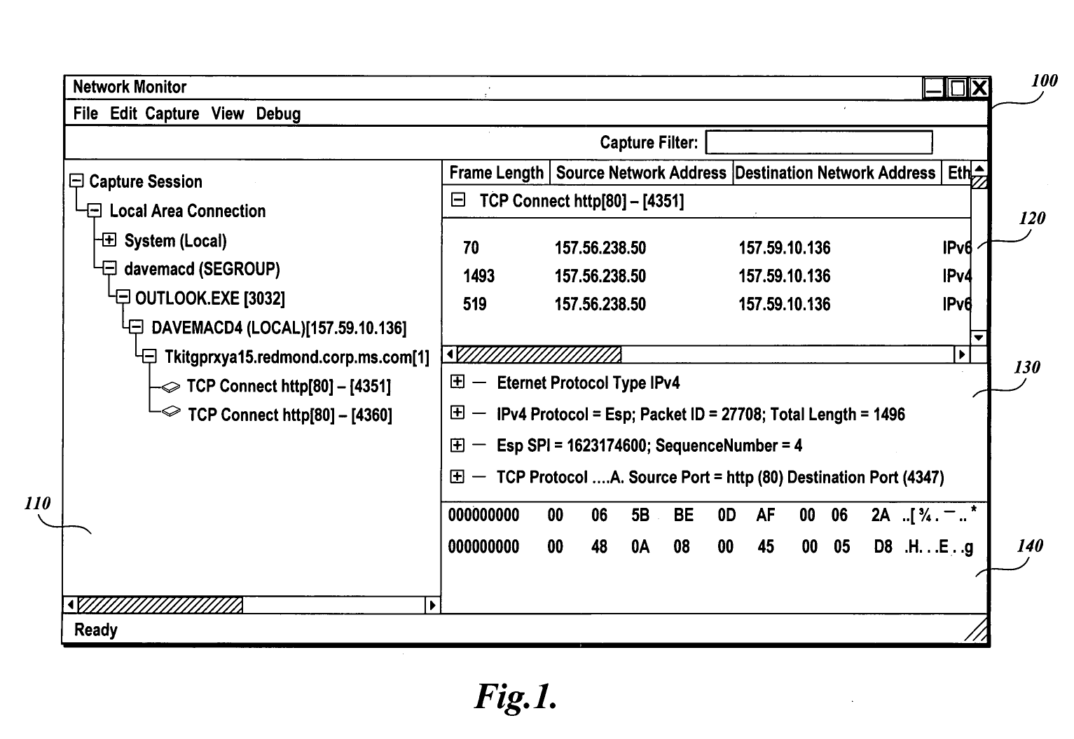

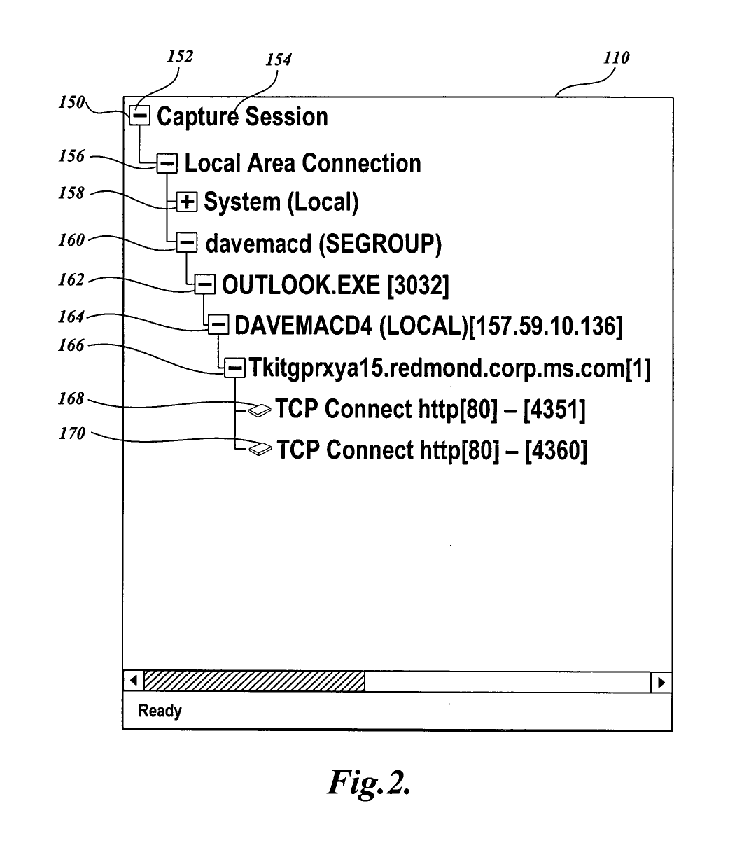

Network monitors capture frames from a stream on a network and output the frames in a human-readable format. Often a network monitor is coupled to a graphical user interface (GUI) so that human operators can easily interact with the monitor. Typically, the visual elements of a GUI are contained in windows. A window is a bounded region of a display that is dedicated to presenting a particular software object or set of software objects and/or providing a particular set of functions, i.e., actions. A window may, or may not, be divided into panes. A pane is a bounded subregion within a window that is usually dedicated to working with a subset of the software objects and/or functions provided by the containing window. FIG. 1 exhibits an exemplary network monitor GUI comprising a window 100 containing four panes. At the top of the window 100 is a title bar and in the title bar is the title “Network Monitor.” Below the title bar is a menu bar containing the menus File, Edit, Capture, and View. Below the menu bar is a field labeled “Capture Filter:”. At the bottom of the window 100 is a status field containing the status indicator “Ready.” Below the bar containing the capture filter field are the four panes. A pane to the left is a Capture Pane 1 10. A pane on the top right is a Frame Pane 120. A pane in the middle right is a Frame Detail Pane 130. A pane on the bottom right is a Frame Data Pane 140. Each of the four panes is illustrated in FIGS. 2 through 5 and described in detail below.

Preferably, the information represented by the visual elements displayed in a network monitor window such as the exemplary Network Monitor Window 100 shown in FIG. 1, is provided by parsing network frames using protocol parsers. Preferably, the protocol parsers are described by one or more protocol scripts that are read by the network monitor and used to form protocol parsers stored in memory. Those skilled in the art will appreciate that a protocol parser script is a file, preferably human readable, used to form a set of protocol parsers that are used by a network monitor to parse frame data into human readable formats. For example, a network monitor reads in one or more protocol parser descriptions from a protocol script, assembles protocol parsers and stores the protocol parsers in memory. The in-memory protocol parsers are then used to parse the protocol information in frames.

FIG. 2 illustrates the exemplary Capture Pane 110. The Capture Pane 110 displays information about the exemplary frames captured during an exemplary capture session organized hierarchically according to various types of information in the frames. The hierarchical organization is represented by a tree. A tree is a data structure containing one or more nodes that are linked together in a hierarchical fashion. A tree of captured frame information for an exemplary capture session represented in the Capture Pane 110 is denoted as a capture tree in this description. Nodes in the capture tree contain information about the captured frames. The hierarchical relationships between the nodes in the capture tree are represented by indentation according to information type. Exemplary types of information in capture tree nodes are network device IDs and/or descriptions, computer user context, applications, computer users, network addresses, network ports, and network connections. Other types of information may be available in frames. The types of information shown in the capture tree nodes in FIG. 2 should be construed as exemplary and not limiting.

Each node in the capture tree is identified by a label. In the exemplary Capture Pane 110, the top node 150 has the label “Capture Session” and represents a capture session. Within the capture session are exemplary conversations assembled from the captured frames and represented by the nodes contained the Capture Session node 150. Local Area Connection node 156 contains system and user group conversations, represented by a System (Local) node 158 and a davemacd (SEGROUP) node 160, “davemacd” being the name of a user. The davemacd (SEGROUP) node 160 contains an application conversation OUTLOOK.EXE [3032] node 162. The OUTLOOK.EXE [3032] node 162 contains a computer DAVEMACD4 (LOCAL)[157.59.10.136] node 164. The DAVEMACD4 (LOCAL)[157.59.10.136] node 164 contains a web address conversation Tkitgprxya15.redmond.corp.ms.com[1] node 166. The Tkitgprxya15.redmond.corp.ms.com[1] node 166 contains two connection conversation nodes, namely a TCP Connect http[80]-[4351] node 168 and a TCP Connect http[80]-[4360] node 170.

In addition, each node in the capture tree includes an icon. The icons in FIG. 2 are located to the left of the respective labels. Most of the illustrated nodes have a square “box” icon located to the left of the label and may be viewed as open or closed. If a node is closed, the contained nodes are not visible and the box icon contains a plus sign (+), e.g., the System (Local) node 158. If a node is open, the contained nodes are displayed below the node and the box icon contains a minus sign (−), e.g., the Capture Session node 150. If a node does not contain other nodes, the node may be represented by a label or a label and an icon, usually indicating the node's function, e.g., TCP Connect http[80]-[4351] node 168. In FIG. 2, the Capture Session node 150 contains the Local Area Connection node 156. Thus, the Capture Session node 150 has an open icon. Similarly, the Local Area Connection node 156 contains the System (Local) node 158 and the davemacd (SEGROUP) 160 node; the davemacd (SEGROUP) node 160 contains the OUTLOOK.EXE [3032] node 162; the OUTLOOK.EXE [3032] node 162 contains the DAVEMACD4 (LOCAL)[157.59.10.136] node 164; the DAVEMACD4 (LOCAL)[157.59.10.136] node 164 contains the Tkitgprxya15.redmond.corp.ms.com[1] node 166; and the Tkitgprxya15.redmond.corp.ms.com[1] node 166 contains the TCP Connect http[80]-[4351] node 168 and the TCP Connect http[80]-[4360] node 170.

A capture tree in a capture pane, such as the exemplary Capture Pane 110 illustrated in FIG. 2 and described above, provides a graphic representation of associations of network items such as, but not limited to, a capture session and a plurality of network connections; a network connection and a plurality of user groups; a user group and a plurality of computer software applications; a computer software application and a plurality of computer users; a computer user and a plurality of network devices; and a network device and a plurality of network connections. When a node in the capture tree is selected, details concerning the conversation represented by the node appear in the Frame Pane 120, Frame Detail Pane 130, and Frame Data Pane 140.

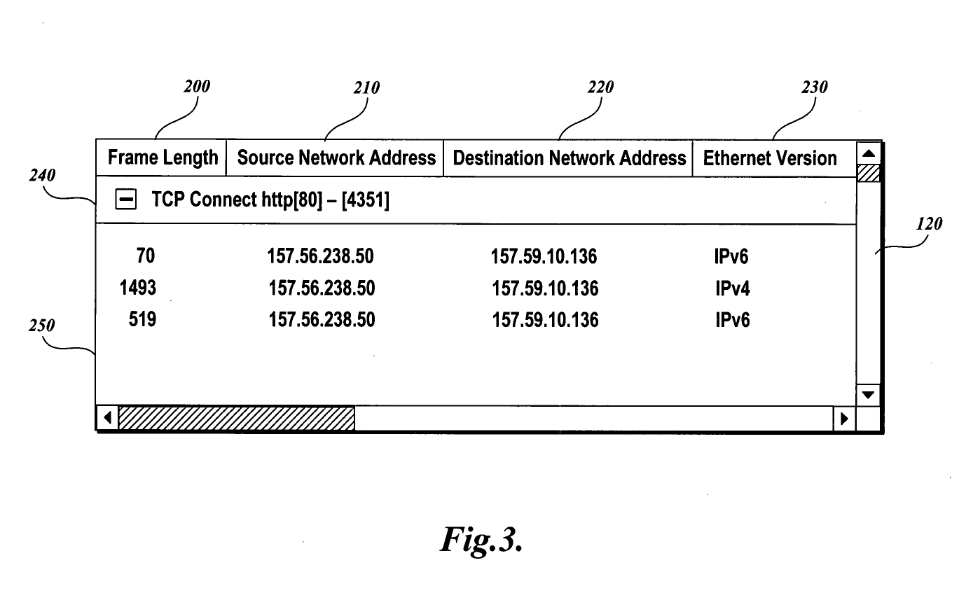

The Frame Pane 120 displays summary information about the frames in a conversation. For example, if a connection conversation is selected in the Capture Pane 110, summary information about the frames in the connection conversation appear in Frame Pane 120. FIG. 3 illustrates an exemplary Frame Pane 120 that displays exemplary summary information about the connection conversation represented by the TCP Connect http[80]-[4351] node 168. The frame information is provided by data rows, i.e., frame data rows, organized according to columns. The exemplary columns in the Frame Pane 120 are Frame Length 200, Source Network Address 210, Destination Network Address 220, and Ethernet Version 230. Below the column headers is a frame title bar 240. The frame title bar contains the label of the selected conversation, e.g., TCP Connect http[80]-[4351]. Below the frame title bar are three exemplary frame data rows 250. The first frame data row contains 70, 157.56.238.50, 157.59.10.136, and IPv6. The second frame data row contains 143, 157.56.238.50, 157.59.10.136, and IPv4. The third frame data row contains 519, 157.56.238.50, 157.59.10.136, and IPv6. The exemplary Frame Pane 120 shows that the connection conversation TCP Connect http[80]-[4351] contains three frames as represented by the three frame data rows. Each frame has a frame length (70, 1493, or 519), source network address (all 157.56.238.50), destination network address (all 157.59.10.136), and Ethernet version (IPv6, IPv4, or IPv6). Thus, for example, the first frame has a frame length 70, source network address 157.56.238.50, destination network address 157.59.10.136, and Ethernet version IPv6.

The number of columns and the column names for frames in a selected conversation displayed in the Frame Pane 120 are customizable, using protocol elements defined in a protocol script. Certain elements in a protocol script, i.e., tags, describe the column names for displayable data in frames. Protocol scripts and tags are described in more detail below. A network monitor provides a way to use properties defined in the protocol script and renders the appropriate columns and column names in Frame Pane 120. The text, number, and placement of tags vary from protocol script to protocol script. Thus, the number of columns and the column names illustrated in FIG. 3 and described above should be construed as exemplary and not limiting.

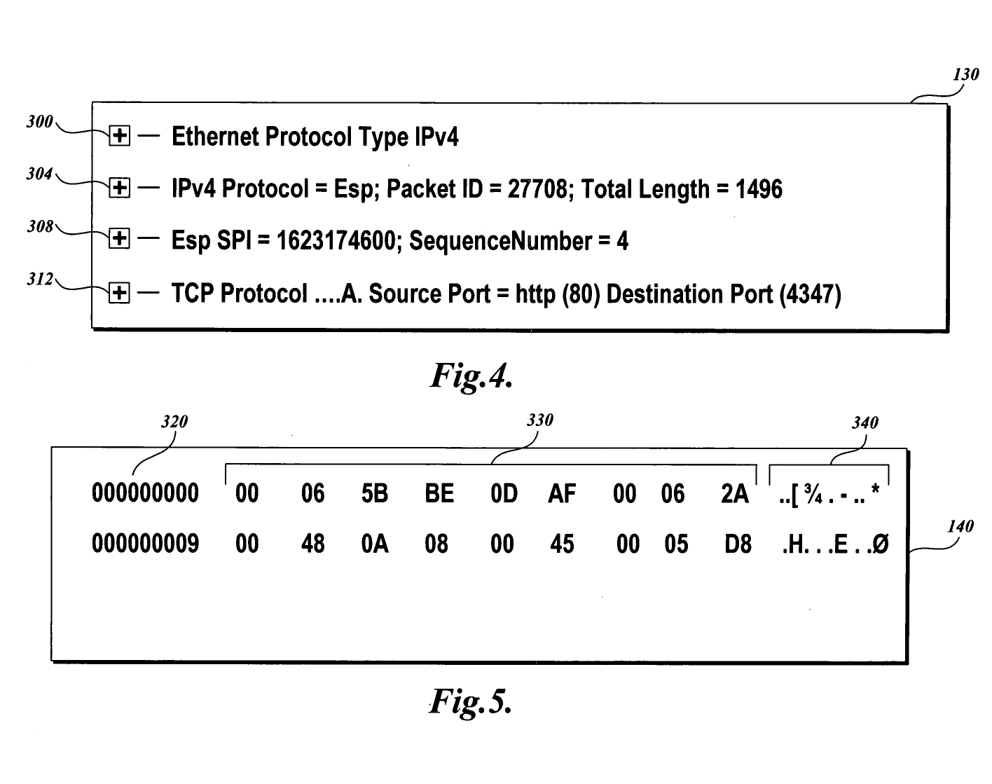

When a frame data row in the Frame Pane 120 is selected, the parsed frame information appears in the Frame Detail Pane 130. FIG. 4 illustrates an exemplary Frame Detail Pane 130. The Frame Detail Pane 130 uses trees containing nodes, similar to the tree in the Capture Pane 110, to organize the protocols parsed from a frame. The Frame Detail Pane 130 contains four closed nodes that can each be opened into a tree containing information about the protocols used in the frame. The first tree node 300 contains information about a protocol identified by the name “Ethernet Protocol Type IPv4.” The second tree node 304 contains information about a protocol identified by the name “IPv4 Protocol” including “Esp; Packet ID=27708; Total length=1496.” The third tree node 308 contains information for protocol “Esp SPI” including “1623174600; SequenceNumber=4.” The fourth tree node 312 contains information about a protocol identified by the name “TCP Protocol” including “. . . . A. Source Port=http(80) Destination Port(4347).”

When a frame data row in the Frame Pane 120 is selected, in addition to the parsed frame information appearing in the Frame Detail Pane 130, the raw, i.e., unparsed, frame information appears in the Frame Data Pane 140. FIG. 5 illustrates an exemplary Frame Data Pane 140. The information in the data frame pane 140 is presented as data rows divided across three columnar sections. The first or left columnar section 320 of the first data row contains the hexadecimal number 00000000. The second or middle columnar section 330 of the first data row contains the nine hexadecimal numbers 00 06 5B BE 0D AF 00 06 2A. The third or right columnar section of the first data row contains the ASCII interpretation of the hexadecimal, the characters . . [¾.-. .*. The first or left columnar section 320 of the second data row contains the hexadecimal number 00000009. The second or middle columnar section 330 of the second data row contains the nine hexadecimal numbers 02 48 0A 08 00 45 00 05 D8. The third or right columnar section of the second data row contains the characters .H . . . E. .Ø. The first columnar section 320 is a column of hexadecimal numbers that indicate the starting address of the data in a row. For example, the first data row begins at address “0” thus the first number in the first or left section 320 is 00000000. The second or middle columnar section 330 comprises nine columns of two digit hexadecimal numbers. Each number represents one byte of data, e.g., 5B. The third or right columnar section 340 comprises nine columns of single characters. Each character is the American Standard Code for Information Interchange (ASCII) character corresponding to a two digit hexadecimal number in the corresponding column position in middle section 330. For example, the second hexadecimal number in the second data row of the middle section 330 is “48” thus the ASCII character “H” is the second character in the second data row of the right section 340. ASCII character codes that denote unprintable characters, e.g., 0D the carriage return character, are represented by a dot (.).

As illustrated in FIGS. 1 through 5 and described above, selecting a node in the Capture Pane 110 causes information for the frames in the conversation represented by the node to appear in the Frame Pane 120. Selecting a data row of frame information in the Frame Pane 120 causes parsed protocol information for the frame to appear in the Frame Detail Pane 130 and unparsed protocol information for the frame to appear in Frame Data Pane 140. The displayed information allows conversations in a capture session to be examined. In addition to examining conversations and frames in conversations, protocol scripts and the protocol parsers generated from protocol scripts can be examined and modified by entering a “debug” mode. An exemplary way of entering the debug mode is to select a “Debug This Frame” item (not shown) in the Debug menu in the menu bar of the window 100. There may be other ways to, e.g., keyboard shortcuts, for entering the debug mode. Hence, selecting the “Debug This Frame” menu item to enter the debug mode should be construed as exemplary and not limiting.

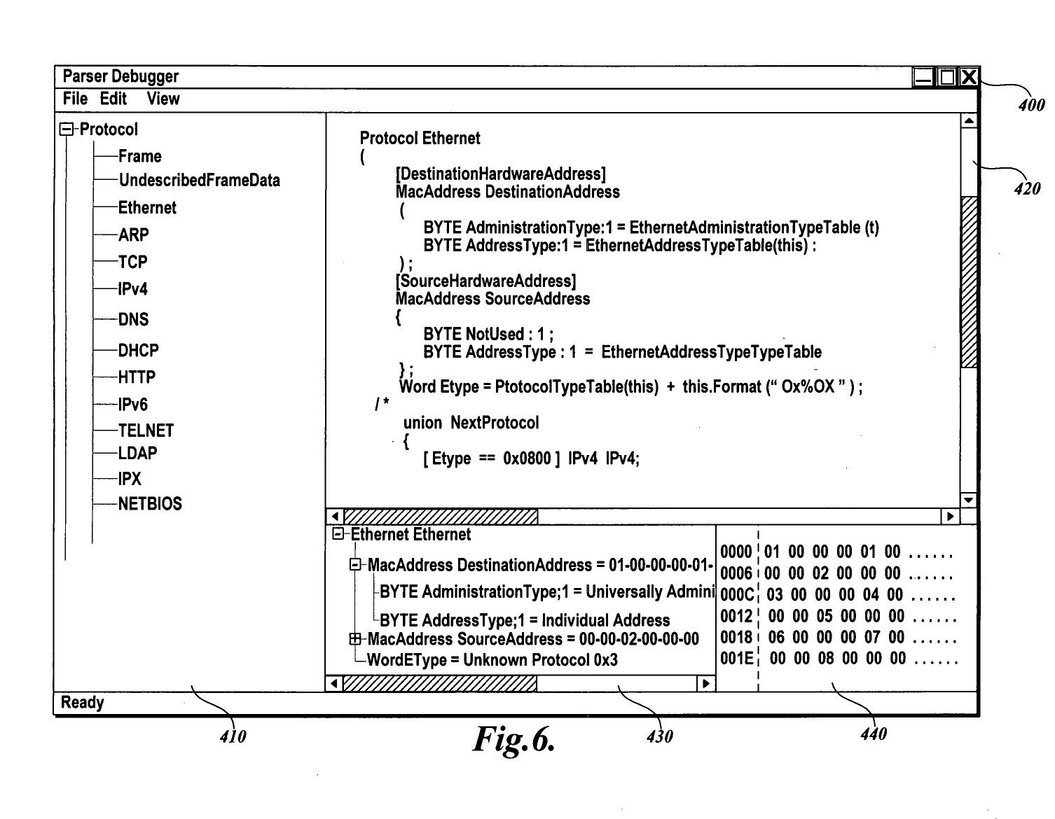

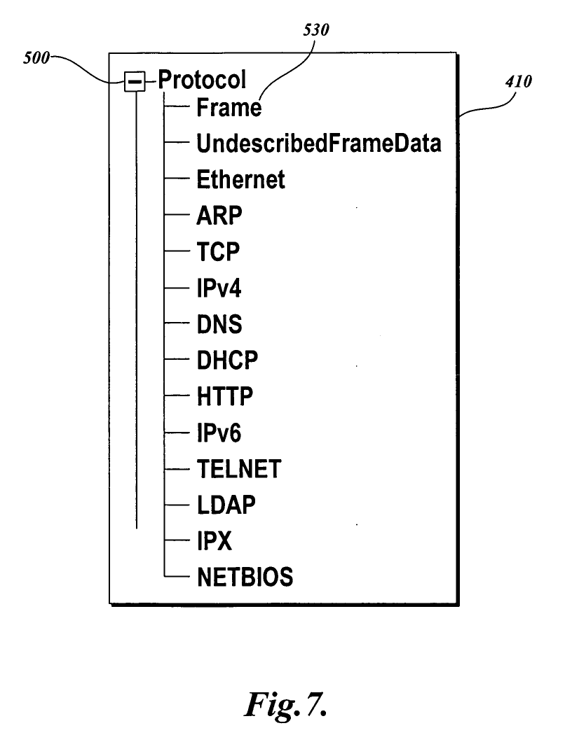

In the example described herein, a frame is selected for debugging by selecting the frame in the Frame Pane 120 and selecting the Debug This Frame menu item in the Debug menu. Selecting the Debug This Frame menu item in the Debug menu causes the debug mode to be entered. When the debug mode is entered, the Network Monitor Window 100 is replaced by a Parser Debugger Window 400, an example of which is shown in FIG. 6. The Parser Debugger Window 400 dynamically represents the execution of network protocol scripts and enables the setting of breakpoints in network protocol parser scripts and single stepping through network protocol parser scripts. The Parser Debugger Window 400 also enables the dynamic modification of network protocol scripts and allows the modifications to be applied to a protocol parser while the protocol parser is being used. More specifically, the exemplary Parser Debugger Window 400 illustrated in FIG. 6 contains four panes. The Parser Debugger Window 400 has a title bar at the top containing the title Parser Debugger. Below the title bar is a menu bar containing the menus File, Edit, and View. At the bottom of the parser debugging window 400 is a status field containing the status indicator Ready. Below the menu bar are the four panes. The left pane is a Protocol Pane 410. The top right pane is a Script Source Pane 420. The bottom middle pane is a Parsed Script Pane 430. The bottom right pane is a Script Data Pane 440. Each of the four panes is illustrated in FIGS. 7 through 10 and described in detail below.

FIG. 7 illustrates the exemplary Protocol Pane 410. The Protocol Pane 410 displays an exemplary protocol parser tree 500 that is formed from one or more protocol scripts and made available in the network monitor. The top node in the protocol parser tree 500 is labeled “Protocol” and has an open icon. Below the top node are the names of the exemplary protocol parsers available in the network monitor comprising Frame, UndescribedFrameData, Ethernet, ARP, TCP, IPv4, DNS, DHCP, HTTP, IPv6, Telnet, LDAP, IPX, and NETBIOS. The name “UndescribedFrameData” is used to view frames containing data that cannot be matched to any of the listed protocol parsers. Each of the exemplary protocol parsers listed may or may not be included in a protocol script and made available in a network monitor. Parsers for protocols other than those illustrated in FIG. 7 may be inserted into a protocol script and made available in a network monitor. Thus, the number and names of protocol parsers should be construed as exemplary and not limiting.

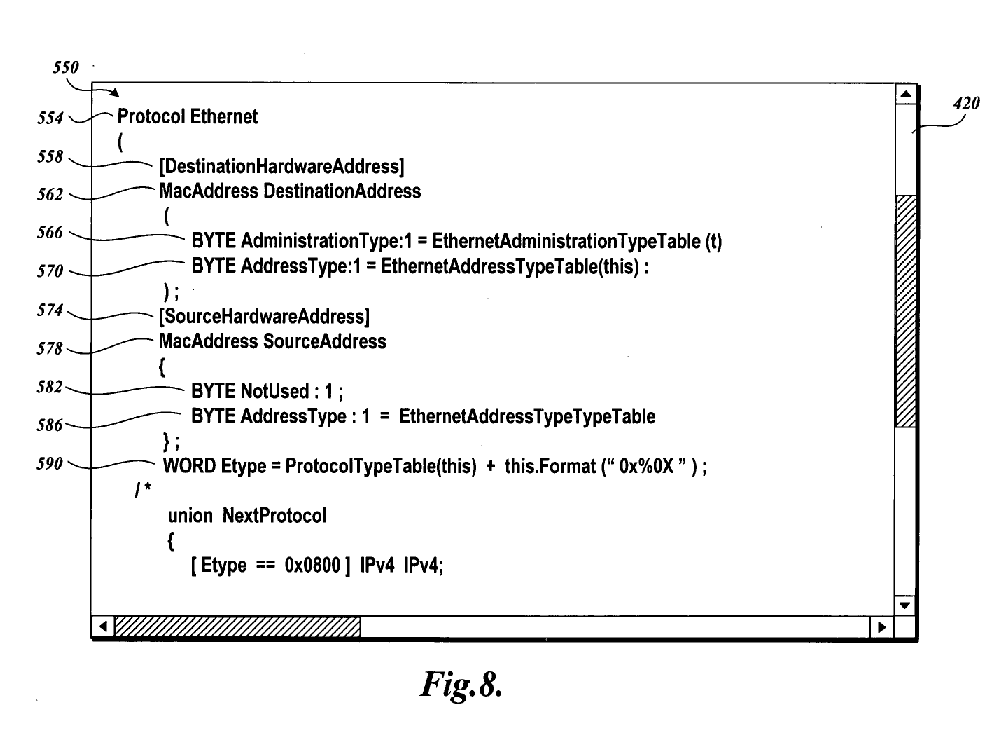

When the name of a protocol parser is selected from the protocol parser tree 500, a protocol parser description, i.e., script source, from a protocol parser script appears in the Script Source Pane 420. FIG. 8 illustrates the exemplary Script Source Pane 420. The script source pane contains an exemplary protocol parser script 550 that is used to generate a protocol parser. For example, line 554 of the protocol parser script 550 contains the identifier Protocol Ethernet, which identifies the protocol specified in the protocol parser script as an Ethernet protocol. Thus, an Ethernet protocol parser can be generated from the protocol parser script 550. The computer language, symbols, and syntax used to describe protocols is implementation specific. Thus, the computer language, symbols, and syntax used to describe protocols in the protocol parser script 550 and the contents of the protocol parser script 550 should construed as exemplary and not limiting. The next line of protocol parser script 550, line 558 contains the identifier [DestinationHardwareAddress], which is a “tag” that identifies the next line, line 562, as a hardware address for a machine that is the destination of a frame sent over a network. In certain implementations, such tags are enclosed in square brackets ([ ]). Tags may be used to identify a property, which, then available in the UI as a data column in a window or pane, e.g., a data column in Frame Pane 120 illustrated in FIG. 3 and described above. The next line 562 contains the identifier MacAddress DestinationAddress, which specifies that a destination address is of the type “MAC address.” Those skilled in the art will appreciate that a MAC address is a unique network address of a physical network device. The next line 566 contains the identifier BYTE AdministrationType:1=EthernetAdministrationTypeTable (t), which specifies that the first bit a byte designated as an “administration type” is set to a value taken from an Ethernet administration type table. The next line 570 contains the identifier BYTE AddressType:1=EthernetAddressTypeTable(this):, which specifies that the first bit in a byte designated as an “address type” is set to a value taken from an Ethernet administration type table. The following line 574 contains the identifier [SourceHardwareAddress], which is a “tag” that identifies the next line 578, as a hardware address for a machine that is the source of a frame sent over a network. The next line, i.e., line 578, contains the identifier MacAddress SourceAddress, which specifies that a source address is a MAC address. The following line 582 contains the identifier BYTE NotUsed:1;, which specifies that the first bit in a byte is “not used.” The next line 586 contains the identifier BYTE AddressType:1=EthernetAddressTypeTypeTable, which specifies that the first bit in a byte designated as an “address type” is set to the first value of an Ethernet address type table. The following line 590 contains the identifier WORD Etype=ProtocolTypeTable(this)+this.Format (“Ox % OX”);, which specifies that the type “Etype” is a word, i.e., typically two contiguous bytes. The Etype is derived from a protocol type table and has the format Ox % OX. Descriptions formed by lines other than the lines in protocol script 550 may be used to describe an Ethernet parser. Protocol scripts for protocols other than Ethernet can be used to generate a protocol parser. Thus, the protocol script 550 and the contents of protocol script 550 illustrated in FIG. 8 and described above should be construed as exemplary and not limiting.

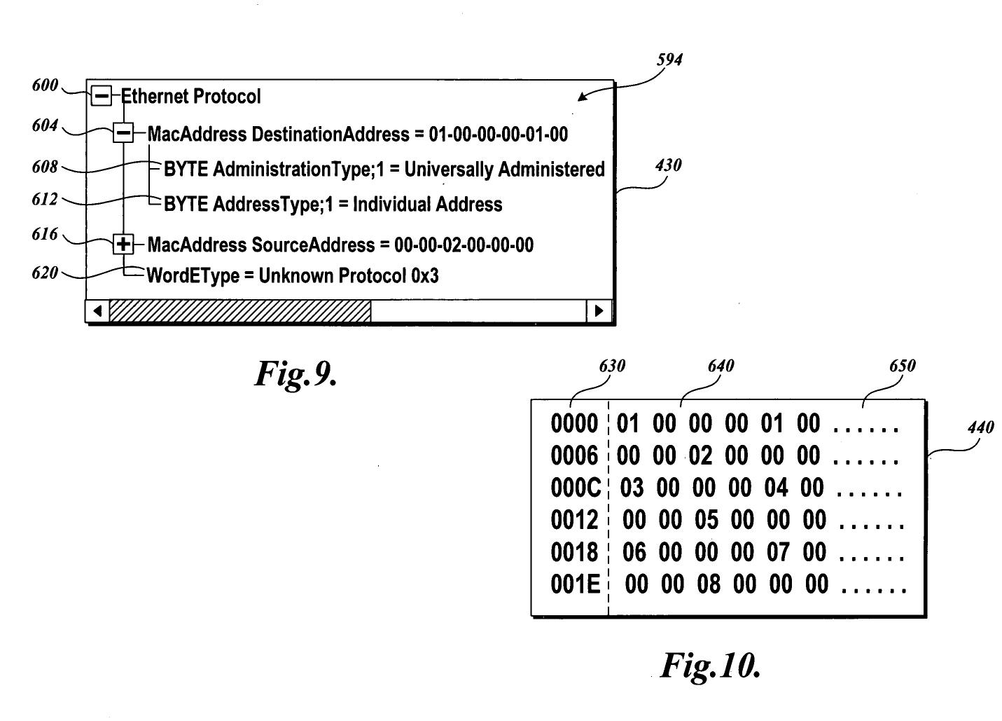

When the name of a protocol parser is selected from the protocol parser tree 500, in addition to the protocol parser script 550 appearing in the Script Source Pane 420, the frame data parsed using the protocol parser generated from the protocol parser script appears in the Parsed Script Pane 430. FIG. 9 illustrates an exemplary Parsed Script Pane 430. The illustrated Parsed Script Pane 430 displays the parsed script in a tree, i.e., a parsed script tree 590, in which the nodes are labeled with the names of the protocols in the protocol script 550 shown in FIG. 8. For example, the Ethernet protocol node 600 in FIG. 9 is labeled “Ethernet Protocol” which is generated by line 554 of protocol script shown in FIG. 8. Similarly, lines 558 and 562 generate a node 604 labeled “MacAddress DestinationAddress=01-00-00-00-01-00”; line 566 generates a node 608 labeled “BYTE AdministrationType;1=Universally Administered”; line 570 generates a node 612 labeled “BYTE AddressType;1=Individual Address”; lines 574 and 578 generate a node 616 labeled “MacAddress SourceAddress=00-00-02-00-00-00”; and line 590 generates a node 620 labeled “WordEType=Unknown Protocol 0x3”. Since the protocol parser script 550 and parsed script tree 594 are exemplary, not all of the lines in exemplary protocol parser script 550 are represented in exemplary parsed script tree 594.

FIG. 10 illustrates the exemplary Script Data Pane 440. The Script Data Pane 440 displays the parsed data as hexadecimal numbers, i.e., the frame data taken directly from the network without formatting imposed upon the data. The data in the Script Data Pane 440 is presented as data rows divided across three columnar sections 630, 640 and 650. All of the data rows in the right columnar section 650 contain six dots. The left columnar section 630 of the first data row contains the hexadecimal number 0000. The middle columnar section 640 of the first data row contains the six hexadecimal numbers 01 00 00 00 01 00. Likewise, the left and middle columnar sections 630 and 640 of data row two contain 0006 and 00 00 02 00 00 00, respectively; data row three contains 000C and 03 00 00 00 04 00, respectively; data row four contains 0012 and 00 00 05 00 00 00, respectively; data row five contains 0018 and 06 00 00 00 07 00, respectively; and data row six contains 001E and 00 00 08 00 00 00, respectively. The left columnar section 630 is a column of hexadecimal numbers that indicate the starting address of the data in a row. For example, the first data row begins at address “0” thus the first row number of the first columnar section 320 is “0000.” The middle columnar section 640 comprises six columns of two digit hexadecimal numbers. Each number represents one byte of data, e.g., 06. The right columnar section 650 comprises six columns of single characters. Each character is the ASCII character corresponding to a two digit hexadecimal number in the corresponding column position in middle section 640. The data shown in Script Data Pane 440 should be construed as exemplary and not limiting.

The four panes in the Parser Debugger Window 400, illustrated in FIGS. 6 through 10 and described above, are used to dynamically represent the execution of network protocol scripts. For example, when a frame is selected in the Frame Pane 120 and the “Debug This Frame” item is selected from the Debug menu the Parser Debugger Window 400 appears. The protocol parsers formed from the protocol script that was loaded by the network monitor when the network monitor started are listed in Protocol Pane 410. When a protocol from the list is selected, the script describing the selected protocol appears in the Script Source Pane 420. When a line in the script is selected, and the “Start” menu item from the View menu is selected, the protocol parser executes line by line with each line being highlighted as the protocol executes. As each line is executed, the information associated with the selected frame and the line of the executing protocol is displayed in the Parsed Script Pane 430 and Script Data Pane 440 enabling the examination of the data to detect errors. If the “Step” menu item from the View menu is selected, one line of the protocol parser is executed and the execution pauses. Such “single stepping” enables closer examination of the data. There may be other ways to, e.g., keyboard shortcuts, for starting the execution of and single stepping through protocol parsers. Hence, selecting the “Start” menu item to start the execution of a protocol parser and selecting the “Step” menu item to single step through a protocol parser should be construed as exemplary and not limiting.

The Parser Debugger Window 400 enables the setting of breakpoints in network protocol parser scripts and single stepping through network protocol parser scripts. First, a line in the script displayed in the Script Source Pane 420 is selected. Then, a breakpoint is set for the selected line by, for example, selecting a “Set Breakpoint” menu item. Thereafter, when the protocol parser is executed, the execution pauses at the breakpoint enabling closer examination of the data associated with the paused line.

The Parser Debugger Window 400 enables the dynamic modification of network protocol scripts and allows the modifications to be applied to a protocol parser while the protocol parser is being used. A part of a line, an entire line, or a group of lines in the script displayed in the Script Source Pane 420 may be selected and modified by keyboard entries and the like. The protocol parser in memory is rebuilt to include the changes and the modified parts of the parser are used to parse the frame being examined. If, for example, the changes correct a parsing problem, the changes to the protocol parser script may be saved.

Typically a network monitor collects frame data, such as the exemplary frame data described above, over a span of time, i.e., a collection span. The data that describes the state of the network and relevant devices on the network during the collection span is “network state data.” Network state data includes, but is by no means limited to, icons that represent applications; user names; group names; name caches that map human readable names to network addresses; and process IDs. The frame data collected during a collection span and the network state data used during the collection span comprise a “capture session.” Using an embodiment of the invention, a network monitor can save a capture session into a “project” file. Later, in a network monitor that uses an embodiment of the invention, the project file can be opened and used to reconstruct the network state that existed during the collection span. Instead of separately rebuilding a network state piece by piece from a perhaps incomplete description of the network state, the network state is automatically reconstructed. The reconstructed network state enables the network monitor to present frame data as it was presented during the original capture session.

For example, node 162 in FIG. 2 represents an application named “Outlook.exe” that has a process ID of 3032. The process ID is unique to the particular instance of the application that was running during the capture session. Such information is valuable in tracking down problems in a capture session. If the process ID were not stored in the project file, the process ID would have to be separately recorded or otherwise lost. The network monitor may operate on a computing device other than the computing device used in the original capture session. The computing device on which the network monitor operates may be connected to a network other than the network of the original capture session. In addition to supporting network troubleshooting, network state data is stored such that the data may not only be viewed but may also be used, e.g., to filter other data.

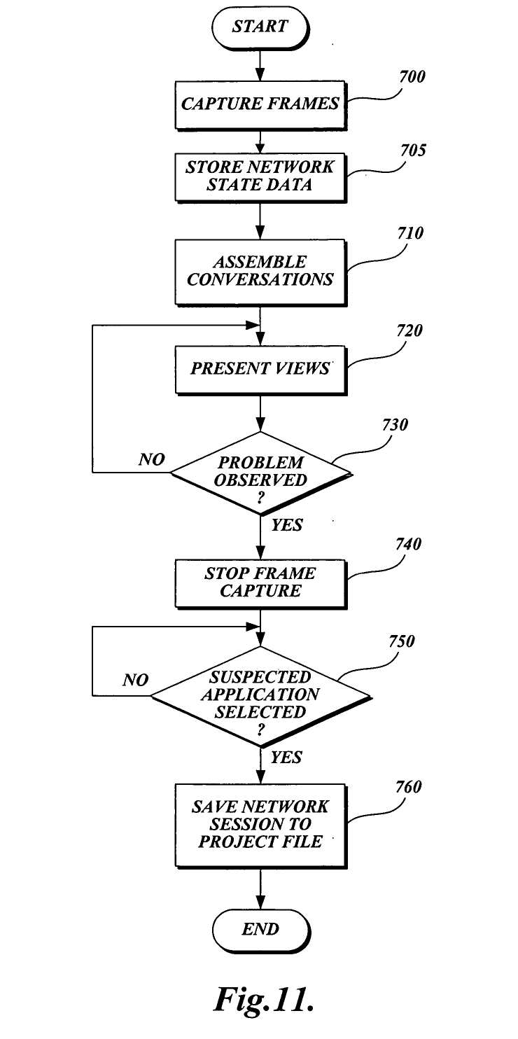

FIG. 11 is a functional flow diagram showing how network monitor captures frame data, gathers capture session data, and saves the capture session to a project file. At block 700, frames are captured by the network monitor. At block 705, data describing the state of the network during a capture, i.e., network state data, is captured by the network monitor. At block 710, the network monitor assembles the captured frames into conversations. At block 720, the network monitor presents the views via the GUI of the network monitor. At block 730, if a problem is observed, the control flow proceeds to block 740. If no problem is observed at block 730, the control flow moves back to before block 720. If a problem is observed at block 730, the control flow proceeds to block 740 where the frame capture is stopped. At block 750, the network monitor waits until a suspected application is selected. If a suspected application is not selected at block 750, the network monitor continues to idle and control flow continues to go back through block 750. If an application is suspected and selected, then the control flows to block 760. At block 760, the capture session containing the suspected application is captured and saved into a project file.

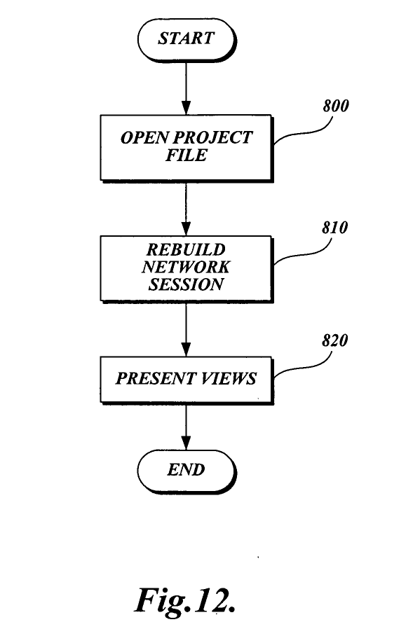

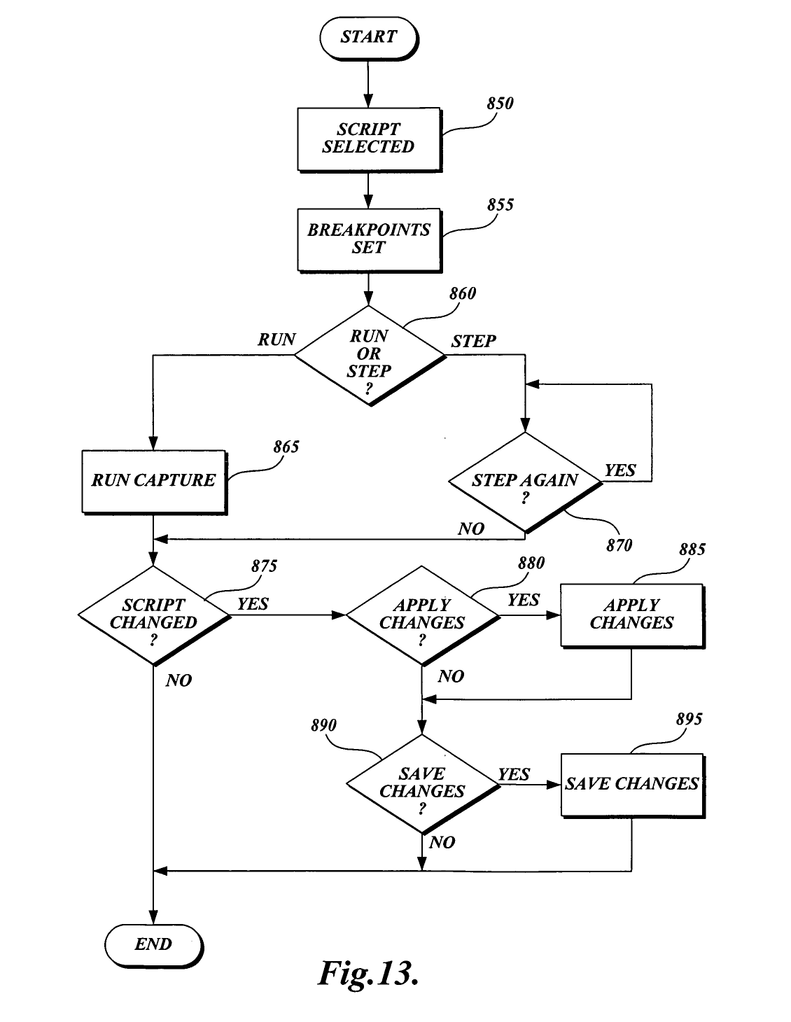

A project file saved using the process described above and illustrated in FIG. 11 is used in the process described by the flow diagram shown in FIG. 12 to reconstruct a capture session. At block 800, the project file is open. At block 710, the project file is used to rebuild the capture session containing the suspected application, which was collected in the process described above and illustrated in FIG. 11. At block 820, views of the rebuilt capture session are presented.

FIG. 13 is an exemplary functional flow diagram showing an exemplary protocol script debugging session using the Parser Debugger Window 400. At block 850, a protocol parser is selected from a list of protocol parsers in the Protocol Pane 410. The text lines describing the selected protocol parser are read from a protocol script loaded when the network monitor started. The text lines are displayed in the Script Source Pane 420. At block 855, breakpoints are set on lines selected from a protocol script displayed in the Script Source Pane 420. At block 860, the control flow branches to either Run or Step. If the Run branch is taken, the control flows to block 865. At block 865, the capture is started and run. When a breakpoint is encountered, the capture is paused. The capture may be restarted. If the Step branch is taken, the control flows to block 870. At block 870, one line in the protocol script is executed, i.e., stepped through. If another line is selected to be stepped through, the control flows back through block 870. After running or stepping is completed, the control flows to block 875. If the protocol script is not changed, the process ends. If the protocol script is changed, control flows to block 880. At block 880, it is determined if changes to the protocol script should be applied to the protocol parsers stored in memory. If it is determined that changes in the protocol script should be applied to protocol parsers in memory, control flows to block 885. At block 885, the changes in the protocol script are applied to protocol parsers in memory and the behavior of the protocol parsers changes in accordance with the changes. If it is determined that changes in the protocol script should not be applied to protocol parsers in memory, control flows to block 890 and the changes in the protocol script are not applied to protocol parsers in memory and thus, the protocol parsers' behavior does not change. At block 890, it is determined if the protocol script changes should be saved. If it is determined protocol script changes should not be saved, the process ends. If it is determined protocol script changes should be saved, control flows to block 895. At block 895, the protocol script changes are saved. Then, the process ends.

Although the subject matter has been described in language specific to structural features and/or methodological acts, it is to be understood that the subject matter defined in the dependent claims is not necessarily limited to the specific features or acts described above. Rather, the specific features and acts described above are disclosed as example forms of implementing the claims.

1. A method of interactively displaying network frame data captured using protocol parsers comprising:
displaying in a Capture Pane information about conversations assembled from frames captured during a network frame data capture session; and
in response to the selection of a conversation assembled from frames captured during a network frame data capture session, simultaneously displaying in at least one other pane frame information about the selected conversation.

2. The method of claim 1, wherein the information about conversations assembled from frames captured during a network frame data capture session displayed in the capture frame is a graphic representation of associations of network items.

3. The method of claim 2, wherein the network items are chosen from a group comprising:
network connections, user context, computer software applications, user and network devices.

4. The method of claim 2, wherein the network items are displayed in a hierarchal tree.

5. The method of claim 1, wherein the at least one other pane is chosen from a group comprising:
a Frame Pane that displays details regarding conversations assembled from frames captured during a network data capture session;
a Frame Detail Pane that displays information regarding the protocols used in a frame; and
a Frame Data Pane that displays raw frame information.

6. The method of claim 1, including:
displaying in a Protocol Pane information that identifies available protocol parsers; and
in response to the selection of a protocol parser, simultaneously displaying in at least one other pane information about the selected protocol parser.

7. The method of claim 6, wherein the at least one other pane is chosen from a group comprising:
a Script Source Pane that contains the protocol parser script used to generate the protocol parser;
a Parsed Script Pane that displays parsed script in a tree; and
a Script Data Pane that displays parsed data as hexadecimal numbers.

8. A method of capturing and displaying network frame data comprising:
capturing frame data during a capture session using protocol parsers formed from protocol script;
capturing network state data during the capture session; and
simultaneously displaying information about the captured frames and the network state in different panes of a display.

9. The method claimed in claim 8, wherein the captured frame data and the captured network state data is stored prior to the simultaneous display of information about the captured frames and the network state in different panes of a display.

10. The method claim 8, wherein the different panes of the display include a pane that displays information about conversations assembled from frames captured during a capture session.

11. The method of claim 10, wherein the information about conversations assembled from frames captured during a capture session is displayed in a hierarchal manner.

12. The method of claim 10, wherein the information about conversations assembled from frames captured during a capture session are network items chosen from the group comprising: network connections, user context, computer software applications, user and network devices.

13. Computer-readable medium containing computer executable-instructions, when executed:
capture network frame data during a capture session;
assemble conversations from said captured network frame data; and
cause information about assembled conversations to be simultaneously displayed in the panes of a multiple pane display.

14. Computer-readable medium as claimed in claim 13, wherein said computer-executable instructions, when executed, also debugs said parsing of network frame data.

15. Computer-readable medium as claimed in claim 14, wherein debugging said parsing of network frame data includes selecting a protocol script.

16. Computer-readable medium as claimed in claim 15, wherein debugging said network frame data also includes setting breakpoints.

17. Computer-readable medium as claimed in claim 15, wherein debugging said network frame also includes determining of protocol scripts stored in memory have been changed and, if changed, determining if the protocol scripts stored in memory should be changed.

18. Computer-readable medium as claimed in claim 13, wherein said computer-executable instructions, when executed, also cause debugging information to be displayed in the panes of a multiple pane display.

19. Computer-readable medium as claimed in claim 13, wherein said panes of said multiple pane display that display information about assembled conversations include a pane that displays information about assembled conversations in a hierarchal manner.

20. Computer-readable medium as claimed in claim 18, wherein said panes of said multiple pane display that display information about assembled conversations include:
a Frame Pane that displays summary information about assembled conversations;
a frame detail pane that displays protocol information; and
a frame data pane that displays raw frame information.
